(19) United States
(12) Patent Application Publication
(10) Pub. No.: US 2011/0002284 A1
(43) Pub. Date: Jan. 6, 2011

(54) MULTI-TIER NETWORK INTERFERENCE MITIGATION

(76) Inventors: SHILPA TALWAR, Los Altos, CA (US); KERSTIN JOHNSSON, Palo Alto, CA (US); NAGEEN HIMAYAT, Fremont, CA (US); SHU-PING YEH, Mountain View, CA (US); JAROSLAW J. SYDIR, San Jose, CA (US)

Correspondence Address: Caven & Aghevli LLC;c/o CPA Global, P.O. BOX 52050, MINNEAPOLIS, MN, 55402, US

(21) Appl. No.: 12/823,261

(22) Filed: Jun. 25, 2010

Related U.S. Application Data
(60) Provisional application No. 61/223,360, filed on Jul. 6, 2009.

(51) Int. Cl. H04W 16/12

(52) U.S. Cl. 370/329

(57) ABSTRACT

In some embodiments, a femto access point comprises a baseband processor, an RF modulator/demodulator coupled to the baseband processor to modulate/demodulate data for communication within a predetermined frequency range, one or more antennas to coupled to the RF modulator/demodulator to transceive information with one or more wireless devices via a wireless communication link, and a control module to implement a femto transmission-free zone in at least one of a time domain or a frequency domain and in which the femto access point does not transmit data. Other embodiments may be described.

### RELATED APPLICATIONS

This application claims the right of priority under 35 U.S.C. §119(e) from U.S. provisional patent application No. 61/223,360, filed Jul. 6, 2009, the disclosure of which is incorporated herein by reference in its entirety.

### BACKGROUND

A femto access point (FAP) is a lower power micro base station (BS) which typically operates in a licensed portion of the electromagnetic spectrum. Femto access points may be deployed in a local area to enhance wireless service coverage and/or performance in a wireless wide area network (WWAN). Femto access points may be deployed in buildings or other locations, such as at the edge of a network cell, in which performance of the wireless wide area network is degraded. Femto access points may be backhauled to the network via a broadband connection to the network, for example via a cable, fiber, and/or digital subscriber line, such that a client device connects to the network via the locally disposed femto access point rather than via a remotely disposed base station (BS) or a base transceiver station (BTS) of the network.

In wireless networks such as cellular or other wireless broadband networks, frequency spectrum is a valuable resource that may be controlled to optimize network performance. In some circumstances interference between femto access points and base stations may degrade the service quality of network customers. Thus, techniques to reduce interference between femto access points and network base stations may find utility.

### BRIEF DESCRIPTION OF THE DRAWINGS

The detailed description is described with reference to the accompanying figures.

FIGS. 1A and 1B are a schematic illustration of a wireless wide area network, according to some embodiments.

FIG. 2 is a schematic illustration of a femto access point, according to some embodiments.

FIG. 3 is a schematic illustration of a wireless device according to some embodiments.

FIG. 4 is a flow diagram illustrating operations in a method to manage transmission power of a femto access point, according to some embodiments.

FIG. 5 is a flow diagram illustrating operations in a method to manage interference generated by a femto access point, according to some embodiments.

FIGS. 6-9 are schematic illustrations of femto transmission power levels in a method to manage interference generated by a femto access point, according to some embodiments.

### DETAILED DESCRIPTION

Described herein are exemplary methods to manage data transmission from a femto access point and embodiments of femto access points which implements such methods. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlaying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

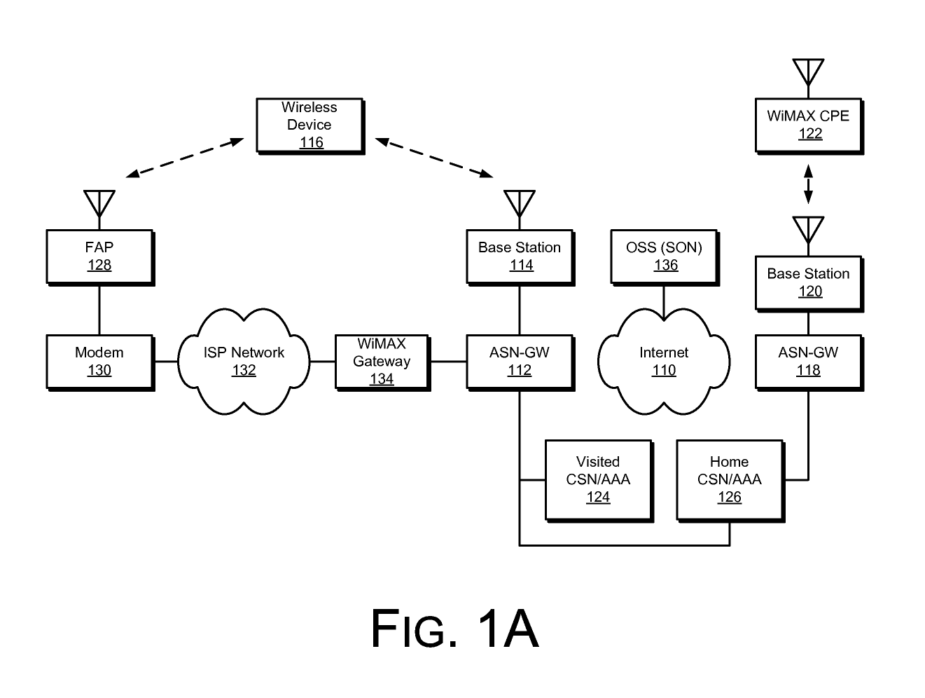

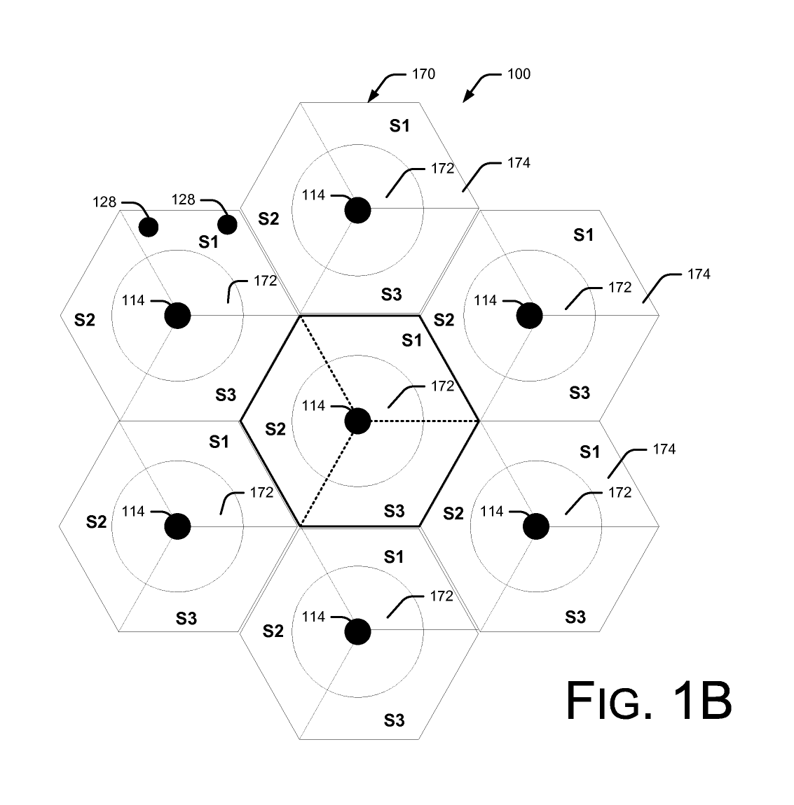

FIGS. 1A and 1B are a schematic illustration of a wireless wide area network, according to some embodiments. Referring now to FIG. 1, a block diagram of a wireless wide area network in accordance with one or more embodiments will be discussed. As shown in FIG. 1, network 100 may be an internet protocol (IP) type network comprising an Internet 110 type network or the like that is capable of supporting mobile wireless access and/or fixed wireless access to internet 110. In one or more embodiments, network 100 may be in compliance with a Worldwide Interoperability for Microwave Access (WiMAX) standard or future generations of WiMAX, and in one particular embodiment may be in compliance with an Institute for Electrical and Electronics Engineers 802.16 standard (IEEE 802.16-2009). In one or more alternative embodiments network 100 may be in compliance with a Third Generation Partnership Project Long Term Evolution (3GPP LTE) or a 3GPP2 Air Interface Evolution (3GPP2 AIE) standard, and/or a future generation cellular broadband network standard. In general, network 100 may comprise any type of orthogonal frequency division multiple access (OFDMA) based wireless network, and the scope of the claimed subject matter is not limited in these respects. As an example of mobile wireless access, access service network gateway (ASN-GW) 112 is capable of coupling with base station (BS) 114 to provide wireless communication between wireless device (SS) 116 and Internet 110. Wireless device 116 may comprise a mobile type device or information handling system capable of wirelessly communicating via network 100, for example a notebook type computer, a cellular telephone, a personal digital assistant, or the like. ASN-GW 112 may implement profiles that are capable of defining the mapping of network functions to one or more physical entities on network 100. Base station 114 may comprise radio equipment to provide radio-frequency (RF) communication with wireless device 116, and may comprise, for example, the physical layer (PHY) and media access control (MAC) layer equipment in compliance with an IEEE 802.16-2009 type standard. Alternatively, base station 112 may also be referred to as a base transceiver station (BTS) in one or more embodiments. Base station 114 may further comprise an IP backplane to couple to Internet 110 via ASN-GW 112, although the scope of the claimed subject matter is not limited in these respects.

Network 100 may further comprise a visited connectivity service network/authentication, authorization, and accounting (CSN/AAA) server 124 capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VOIP) gateways, and/or internet protocol (IP) type server functions, or the like. However, these are merely example of the types of functions that are capable of being provided by visited CSN/AAA or home CSN/AAA 126, and the scope of the claimed subject matter is not limited in these respects. Visited CSN/AAA 124 may be referred to as a visited CSN/AAA in the case for example where visited CSN/AAA 124 is not part of the regular service provider of wireless device 116, for example where wireless device 116 is roaming away from its home CSN/AAA such as home CSN/AAA 126, or for example where network 100 is part of the regular service provider of wireless device but where network 100 may be in another location or state that is not the main or home location of wireless device 116. In a fixed wireless arrangement, WiMAX type customer premises equipment (CPE) 122 may be located in a home or business to provide home or business customer broadband access to internet 110 via base station 120, ASN-GW 118, and home CSN/AAA 126 in a manner similar to access by wireless device 116 via base station 114, ASN-GW 112, and visited CSN/AAA 124, a difference being that WiMAX CPE 122 is generally disposed in a stationary location, although it may be moved to different locations as needed, whereas wireless device may be utilized at one or more locations if wireless device 116 is within range of base station 114 for example. In accordance with one or more embodiments, operation support system, self organizing networks (OSS (SON)) sever 136 may be part of network 100 to provide management functions for network 100 and to provide interfaces between functional entities of network 100. Network 100 of FIG. 1 is merely one type of wireless network showing a certain number of the components of network 100, however the scope of the claimed subject matter is not limited in these respects.

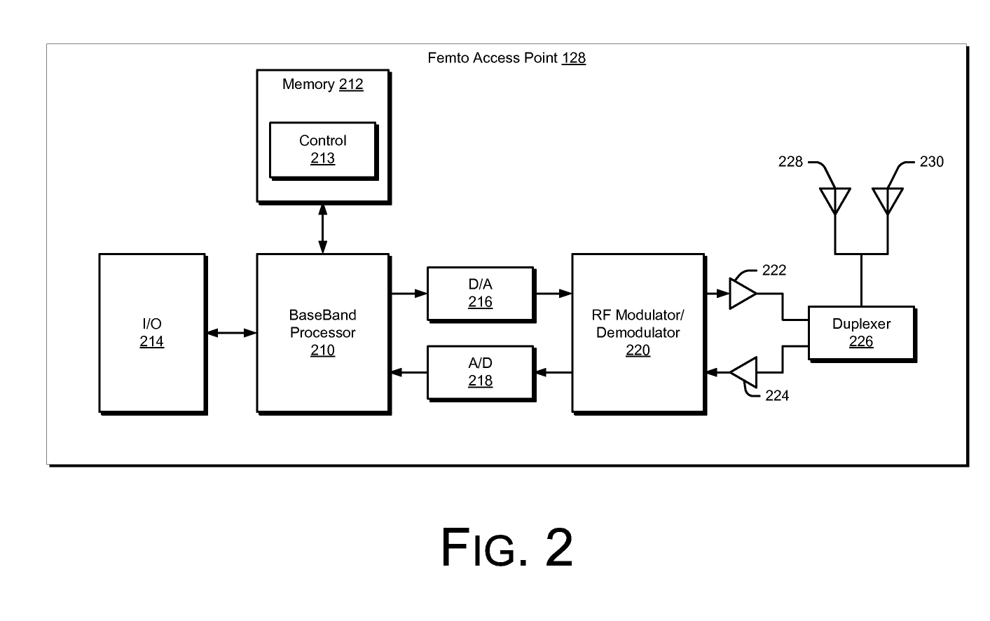

In some embodiments, wireless device 116 may couple to Internet 110 via a wireless communication link with femto access point (FAP) 128 rather than a wireless communication link with base station 114. As shown in FIG. 1, femto access point 128 comprises a lower power base station device designed enhance the coverage area for wireless devices 116 located at or near the edge, or outside of the coverage are of one or more base stations 114 and/or base stations 120 of network 100. Alternatively, femto access point 128 may increase performance of wireless devices located within buildings that may attenuate or otherwise interfere with wireless communications with base station 114. In such an arrangement, wireless device 116 may communicate with femto access point 128 which is coupled to a modem 130 such as a cable modem, digital subscriber line (DSL) modem, or the like. Femto access point 128 may couple to network 100 via an Internet service provider (ISP) network 132 which may allow femto access point 128 to access the WiMAX network 100 and services via WiMAX gateway 134. As a result, wireless device 116 is capable of coupling to Internet 110 and/or to the services provided by WiMAX network such as, for example, software services, voice over internet protocol (VoIP) services, database access, and so on. Thus, a locally deployed femto access point 128 can enhance access of wireless device 116 to network 100 in situations where wireless device 116 may have difficulty communicating with base station 114 and/or base station 120, although the scope of the claimed subject matter is not limited in this respect. An example block diagram of femto access point 128 is discussed with respect to FIG. 2, below.

Referring now to FIG. 1B, in some embodiments the network 100 may be organized as a cellular network in which a number of cells 170. Each cell 170 is serviced by a base station 114 which may be disposed approximately in the center of the cell 170. In some embodiments the cell may be subdivided into sectors, designated S1, S2, and S3 in FIG. 1B. Typically, each sector covers a 120 degree angle of the cell 170. Various frequency allocation schemes may be implemented by the base stations 114 to reduce interference between adjacent cells 170. By way of example, cellular networks 100 may implement various frequency reuse schemes to reduce interference between adjacent cells.

A region surrounding the base station 114 may be described as the cell center 172. In practice, the region defined as the cell center 172 may be defined by signal strength characteristics rather than geographic boundaries. For example, the cell center 172 may be defined as the geographic region in which the signal strength of the signal from the base station 114 exceeds a minimum threshold. The strength of a signal from the base station 114 decays as the distance from the base station 114 increases. Thus, in practice the border defining the cell center 172 may expand or contract based on factor such as the transmission power implemented by the base station 114 at any particular point in time, geographic features, or physical obstacles in the communication path between a wireless device 116 and the base station 114. In addition, while the border defining the cell center 172 is depicted as a circle having a defined radius, one skilled in the art will recognize that the cell center may not be a uniform circle. Rather, the border may deviate as a function of transmission power, geographic features, physical obstacles, and the like.

The region outside the cell center 172 may be referred to as a cell edge 174. Again, the cell edge 174 may be defined by signal strength characteristics rather than geographic characteristics. For example, the cell edge 174 may be defined by the geographic region in which the signal strength of the signal from the base station 114 is below a threshold. A cell-edge may also be defined if signal-to-interference-plus-noise ratio is below a threshold. The SINR metric not only measures signal strength, but also interference levels at cell-edge (which can be quite high). When cell-edge is defined as users with SINR below a certain threshold, cell-center users are the remaining user associated with that BS.

One or more femto access points 128 may be positioned in the cells 170. As described above, a femto access point 128 may be positioned in an environment in which the signal from the base station 114 is degraded due to the environment (e.g., obstacles such as a building) or due to the distance from the base station 114 a wireless device 116 is located. For example, femto access points 128 may be located near the edge of a network cell 170 to bolster service quality of wireless devices 116 operating in a cell edge 174. Although FIG. 2 shows only two femto access points, one skilled in the art will recognize that a network such as network 100 may comprise more or fewer femto access points 128.

Referring now to FIG. 2, a block diagram of a femto access point 128 in accordance with one or more embodiments will be discussed. FIG. 2 illustrates an example block diagram of femto access point 128 as shown in and described with respect to FIG. 1, above. FIG. 2 depicts the major elements of an example femto access point 128, however fewer or additional elements may be included in alternative embodiments in addition to various other elements that are not shown herein, and the scope of the claimed subject matter is not limited in these respects. Femto access point 128 may comprise a baseband processor 210 coupled to memory 212 for performing the control functions of femto access point 128. Input/output (I/O) block 214 may comprise various circuits for coupling femto access point 128 to one or more other devices. For example, I/O block 214 may include one or more Ethernet ports and/or one or more universal serial bus (USB) ports for coupling femto access point 128 to modem 130 or other devices. For wireless communication, femto access point 128 may further include a radio-frequency (RF) modulator/demodulator for modulating signals to be transmitted and/or for demodulating signals received via a wireless communication link. A digital-to-analog (D/A) converter 216 may convert digital signals from baseband processor 210 to analog signals for modulation and broadcasting by RF modulator/demodulator via analog and/or digital RF transmission techniques. Likewise, analog-to-digital (A/D) converter 218 may convert analog signals received and demodulated by RF modulator/demodulator 220 digital signals in a format capable of being handled by baseband processor 210. Power amplifier (PA) 222 transmits outgoing signals via one or more antennas 228 and/or 230, and low noise amplifier (LNA) 224 receives one or more incoming signals via antennas 228 and/or 230, which may be coupled via duplexer 226 to control such bidirectional communication. In one or more embodiments, femto access point 128 may implement single input, single output (SISO) type communication, and in one or more alternative embodiments femto access point 128 may implement multiple input, multiple output (MIMO) communications, although the scope of the claimed subject matter is not limited in these respects.

One skilled in the art will recognize that the base station 114 may have a structure and components substantially similar to the structure depicted in FIG. 2 for the femto access point 128. In the interest of brevity, the description provided with reference to FIG. 2 will not be repeated in application to a base station.

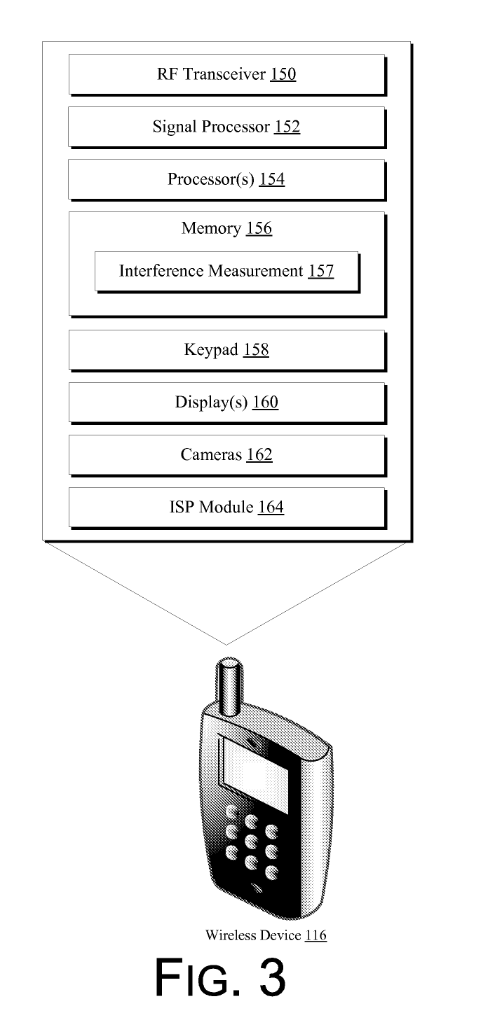

FIG. 3 is a schematic illustration of a wireless device 110 according to some embodiments. Referring to FIG. 3, in some embodiments wireless device 116 may be embodied as a mobile telephone, a personal digital assistant (PDA), a laptop computer, or the like. Electronic device 110 may include an RF transceiver 150 to transceive RF signals and a signal processing module 152 to process signals received by RF transceiver 150.

RF transceiver may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Wireless device 110 may further include one or more processors 154 and a memory module 156. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 154 may be one or more processors in the family of Intel® PXA27x processors available from Intel® Corporation of Santa Clara, Calif. Alternatively, other CPUs may be used, such as Intel's Itanium®, XEON™, ATOM™, and Celeron® processors. Also, one or more processors from other manufactures may be utilized. Moreover, the processors may have a single or multi core design. In some embodiments, memory module 156 includes random access memory (RAM); however, memory module 156 may be implemented using other memory types such as dynamic RAM (DRAM), synchronous DRAM (SDRAM), and the like.

Wireless device 110 may further include one or more input/output interfaces such as, e.g., a keypad 158 and one or more displays 160. In some embodiments electronic device 110 comprises one or more camera modules 162 and an image signal processor 164.

In some embodiments wireless device 110 may include an interference measurement module 157. Interference measurement module 157 measures one or more interference based metrics between a base station 114 and a femto access point 128 in the wireless device 110. By way of example, in some embodiments interference measurement module 157 measures a signal to noise ratio (SINR) for the signal received by the wireless device 116, but other measurements could be used. In the embodiment depicted in FIG. 3 the interference measurement module 157 is implemented as logic instructions stored in the memory module 156, and which may be executed on one or more of the processor(s) in the wireless device 110. In alternate embodiments interference measurement module 157 may be implemented as firmware or may be reduced to hardwired logic circuitry. The particular implementation of the interference measurement module 157 is not critical.

Referring back to FIG. 2, in some embodiments femto access point 128 may include a control module 213 to implement interference management operations in accordance with the description provided herein. In some embodiments the control module 213 may be implemented as logic instructions stored in the computer readable medium of memory 212. When executed by a processor, e.g., the baseband processor 210 or another processor in or coupled to access point 128, the control module may implement one or more operations to manage interference between a femto access point 128 and a base station 114, or between a femto access point and a neighboring femto access point.

In some embodiments the control module 213 implements one or more techniques to reduce co-channel interference with the base station 114. In other embodiments, the control module 213 implements one or more techniques to reduce adjacent or alternate channel interference with the base station 114. In addition, in some embodiments the control module, the base station 114, the SON server 136 and the interference module 157 cooperate to implement fractional frequency reuse techniques to reduce interference between the base station 114 and a femto access point 128, and between multiple femto access points 128. Various techniques will be explained with reference to FIGS. 4-7.

FIG. 4 is a flow diagram illustrating operations in a method to manage transmission power of a femto access point, according to some embodiments. Referring now to FIG. 4, in some embodiments the control module 213 of the femto access point 128 may implement a power control routine that regulates the transmit power of the femto access point 128 in an effort to reduce interference. In general, the technique implemented by the control module 213 attempts to reduce the transmission power level of the femto access point to a level which maintains sufficient power to serve the wireless devices 116 coupled to the femto access point 128 while not unduly interfering with wireless devices 116 coupled to the base station 114.

Thus, at operation 410 the control module 213 of the femto access point 128 sets the transmission power level of the femto access point 128 to an initial value, referred to as P0. The initial power level P0 may be determined by operating standards or may be indicated by SON server or by a hardware or software default associated with the femto access point 128.

At operation 415 the control module 213 of the femto access point 128 receives target signal-to-noise ratio(s) (SINRs) for wireless devices 116 coupled to the network 100 through the femto access point 116. In some embodiments the wireless devices 116 may transmit the target SINRs directly to the femto access point 116. In other embodiments target SINRs may be maintained in a central coordinating server, e.g., a SON server 136, which may transmit the values to the femto access point. In some embodiments the target SINR corresponds to the lowest modulation and coding scheme (MCS).

At operation 420 the control module 213 of the femto access point 128 receives active SINR values from one or more wireless devices 116 coupled to the network through the femto access point 128. In some embodiments, the interference measurement module 157 of the wireless device(s) 116 monitors the SINR of the wireless device(s) 116 coupled to femto access point 116 and transmits the SINR measurement to the femto access point 128, either as part of routine overhead or in response to a request from femto access point 128.

At operation 425 the control module 213 of the femto access point 114 determines a power margin for one or more wireless device(s) 116 coupled to the femto access point 128. In one embodiment the power margin for a wireless device corresponds to the difference between the SINR for the wireless device 116 and the target SINR received in operation 415:

Pmargin(i)=SINR(i)−SINR_Target EQ 1

At operation 430 the control module 213 of the femto access point 128 determines the minimum power margin for the one or more wireless device(s) 116 coupled to the femto access point. In one embodiment the minimum power margin corresponds to the lowest power margin determined in operation 425 for the group of wireless devices 116:

Min_{—}P_Margin=MIN{Pmargin(i)} EQ2

If, at operation 435, the minimum power margin is less than or equal to zero, indicating that there is no margin to reduce the transmit power of the femto access point 128, then control passes back to operation 420. By contrast, if at operation 435 the minimum power margin is greater than zero then control passes to operation 440 and the transmit power of the femto access point 116 is reduced by an amount corresponding to the minimum power margin. Control then passes back to operation 420.

Thus, operations 420-440 define a loop pursuant to which the control module 213 of the femto access point 128 monitors the SINRs of one or more wireless devices 116 coupled to the network 100 through the femto access point 128 and adjusts the transmit power of the femto access point 128 to a minimum level required to maintain the target SINRs of the wireless devices 116. Reducing the transmit power of the femto access point 116 reduces interference with wireless devices 116 proximate the femto access point that are coupled to the network 100 through a base station 114 or to a neighboring femto access point.

In other embodiments, the power control at femto access point may be triggered by interference caused to neighbor devices served by macro-BS. These devices report to serving macro-BS the interference level from femto-AP or their SINR, and the femto-AP is asked by macro-BS or SON server to lower the transmit power such that interference level to device is lowered to an acceptable quality for the device.

In some embodiments the control module 213 of the femto access point 128 may implement a transmission management scheme in which a communication resource is partitioned in at least one of a frequency domain or a time domain, and one or more partitions are reserved as transmission-free zones during which the femto access point 128 operates at a low power rate or does not transmit data at all. Further, in some embodiments wireless devices proximate the femto access point 128 but connected to the network 100 via the base station 114 are scheduled to transmit data during the transmission-free zone for the femto access point. Thus, the femto access point 128 does not create interference with the wireless devices 116 coupled to the network 100 via the base station 114. In some embodiments, the macro-BS may not transmit on a resource, and femto-users that are severely interfered by macro-BS (such as those users located near the cell center), may be served by their femto-access points on that resource.

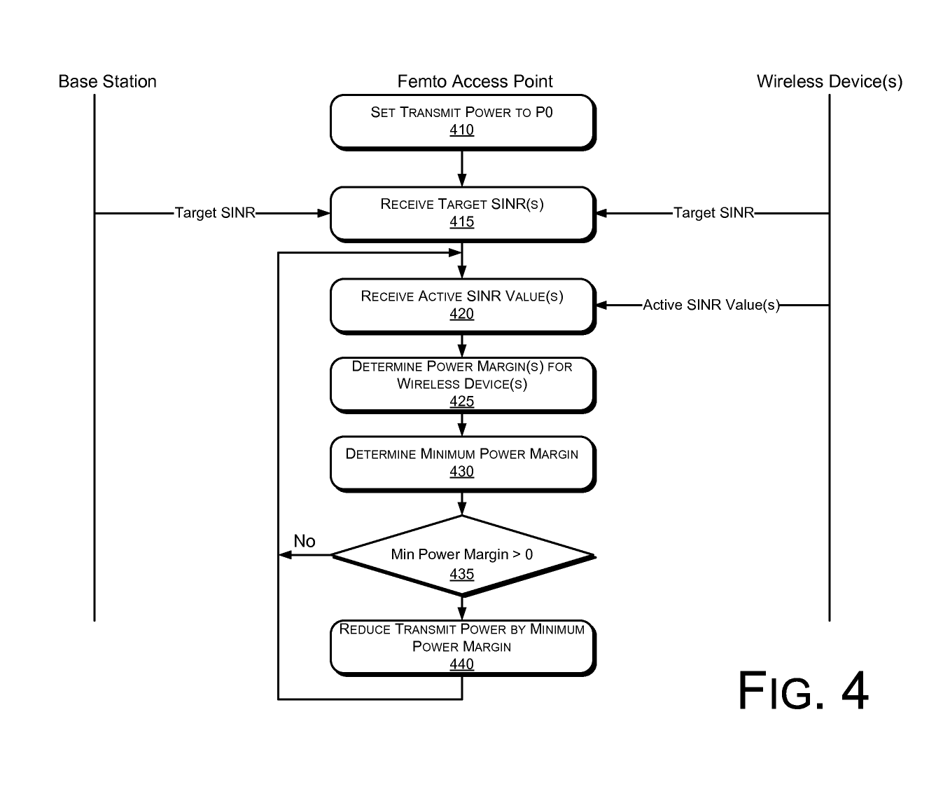

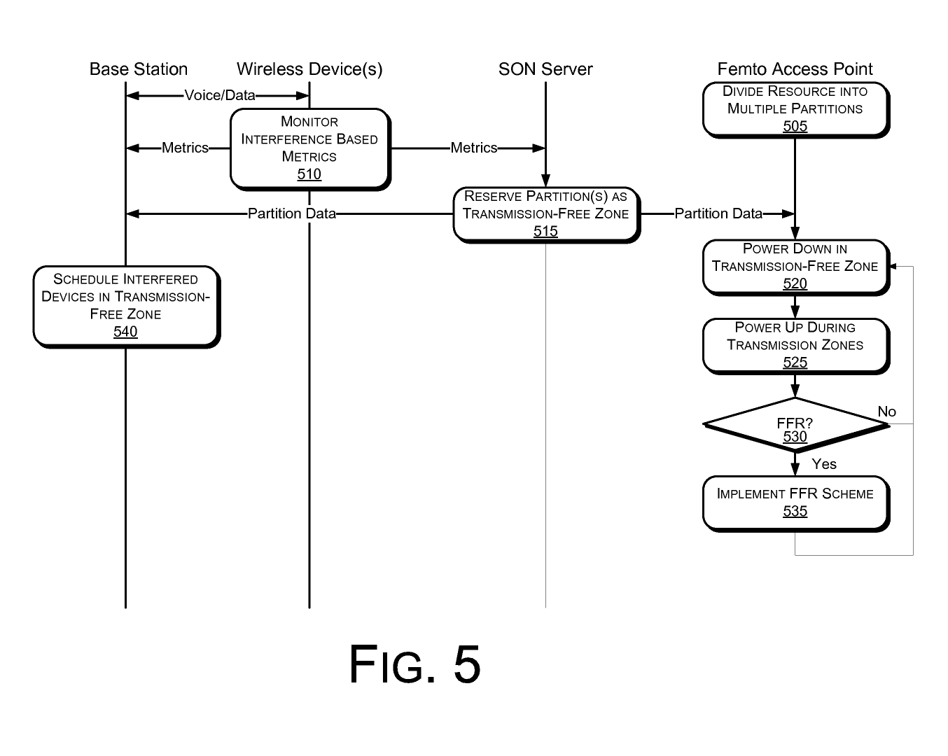

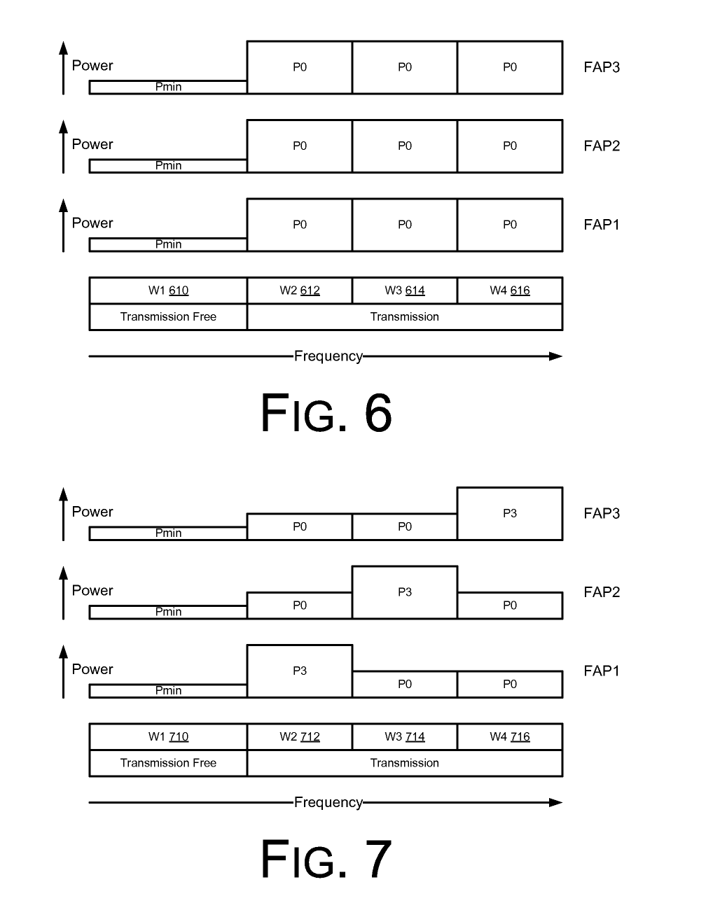

FIG. 5 is a flow diagram illustrating operations in a method to manage interference generated by a femto access point, according to some embodiments, and FIGS. 6-7 are schematic illustrations of femto transmission power levels in a method to manage interference generated by a femto access point, according to some embodiments. Referring first to FIG. 5, at operation 505 the control module 213 divides a communication resource into multiple partitions. By way of example, the communication resource may be divided in either the frequency domain, the time domain, or both.

At operation 510 the wireless devices 116 operating in the vicinity of the femto access point 128 and the base station 114 monitor one or more interference based metrics. By way of example, in some embodiments the wireless devices 116 monitor SINR values for each of the partitions defined in operation 505. The SINR values may be forwarded to the SON server 136 via the femto access point 128 and the base station 114.

At operation 515 one of the partitions is reserved as a transmission-free zone. In some embodiments SON server 136 coordinates which partitions the femto access point(s) will designate as a transmission-free zone. In some embodiments the femto access point 128 operates at power level that is beneath a threshold level in the transmission-free zone, while in alternate embodiments the femto access point 128 does not transmit data at all in the transmission-free zone. The SON server 136 transmits information (e.g., power levels, size, etc.) about the partitions to the femto access point 128 and the base station 114, which in turn may transmit the information to one or more wireless devices 116.

At operation 520 the femto access point 128 powers down in the transmission free zone. As described above, in a frequency domain partition scheme the femto access point 128 may simply cease transmitting in a particular partition of the frequency spectrum in which the femto access point 128 operates. In a time-domain partition the femto access point 128 may power down or cease transmitting during a particular time slot which has been designated as a transmission-free zone.

At operation 525 the femto access point 128 powers up during one or more zones designated as transmission zones. Again, in a frequency domain partition scheme the femto access point 128 may transmit data only in particular partitions of the frequency spectrum in which the femto access point 128 operates. In a time-domain partition the femto access point 128 may power transmit only during one or more time slots which have been designated as a transmission zones.

In some embodiments a femto access point 128 may implement a fractional frequency reuse (FFR) scheme to reduce interference with other femto access points 128 located in close proximity. If, at operation 530, the femto access point 128 does not implement a fractional frequency reuse scheme then control passes back to operation 520. By contrast, if at operation 530 the femto access point 128 implements a fractional frequency reuse scheme then control passes back to operation 535 and the fractional frequency reuse scheme is implemented. Control then passes back to operation 520. In some embodiments, femto access point may implement power control in partitions that are not designated femto-free. One power control scheme is described above with reference to FIG. 4.

Thus, operations 520-535 define a loop pursuant to which the control module 213 of the femto access point 128 regulates transmit power to significantly reduce the transmit power to some minimum level or to completely stop data transmission during one or more partitions in a time domain or a frequency domain. In some embodiments other elements of the network cooperate with the femto access point to schedule data transmission to and from wireless devices 116 that suffer interference from the femto access point(s) 128 in the transmission-free zones. In practice, affected wireless devices 116 will generally be wireless devices that are in close physical proximity to a femto access point 128 but are coupled to the network 100 by a base station 114, such that the femto access point 128 generates interference with the base station 114. Alternatively affected wireless devices 116 may be wireless devices that are connected to the network 100 by a first femto access point 128 but suffer interference from a second femto access point 128.

As described above, partition information is exchanged between the femto access point 128 and the SON server 136. In one embodiment with semi-static operation, the SON server 136 collects information from the base station 114 and all femto-access points 128 in a given area, determines the appropriate parameters for femto-free zone (ex. power, size), and signals these parameters to femto access point(s) 128.

At operation 540 the base station 114 uses the interference information from the devices it serves, and schedules those devices that are severely interfered by femto access points 128 in transmission-free zone. The transmission-free zone as designated by the SON server 136.

Thus, the operations depicted in FIG. 5 reduce interference between a base station and a femto access point 128 by providing specific partitions in at least one of a frequency domain or a time domain as transmission-free zones and scheduling data transmissions for wireless devices affected by interference from the femto access point 128 during the transmission free zones.

FIG. 6 depicts an arrangement in which a communication channel for a set of femto access points 128 are divided in the frequency domain. Referring to FIG. 6, a transmission power management scheme for three femto access points 128 (designated by FAP1, FAP2, FAP3) is depicted. By way of example, the three femto access points may be proximate one another within a single cell, such that the three femto access points transmit in the same frequency band. In the embodiment depicted in FIG. 6 the frequency band is divided into four partitions designated as W1 (610), W2 (612), W3 (614), and W4 (616). The partition W1 610 is designated as a transmission-free zones for the femto access points FAP1, FAP2, FAP3, while the remaining partitions W2-W4 are designated as transmission zones for the femto access points FAP1, FAP2, FAP3.

In the embodiment depicted I FIG. 6 the femto access points FAP1, FAP2, FAP3 reduce their respective transmit powers to a level below a threshold power level, or do not transmit data at all. By contrast, during the transmission partitions W2-W4 the femto access points FAP1, FAP2, FAP3 transmit data at a power level P0. The power level P0 may be determined by SON server based on density of the femto access point(s) 128 in an area. In highly-dense scenarios low power levels (e.g., below 10 dB) may be used to minimize interference amongst femto access points 128. By contrast, in low-density scenarios higher power levels may be used to maximize the data transmission rate at femto access points 128. In another embodiment, the power level may be adjusted based on power control algorithms described previously. In the embodiment depicted in FIG. 6 wireless devices 116 that are affected by interference from the femto access points FAP1, FAP2, FAP3 would transmit during the transmission free zone 610.

FIG. 7 depicts an arrangement in which a communication channel for a set of femto access points 128 are divided in the frequency domain, and in which the femto access points FAP1, FAP2, FAP3 implement a fractional frequency reuse scheme to reduce co-channel interference between the respective access points FAP1, FAP2, FAP3. Referring to FIG. 7, the frequency band is divided into four partitions designated as W1 (710), W2 (712), W3 (714), and W4 (716). The partition W1 710 is designated as a transmission-free zone for the femto access points FAP1, FAP2, FAP3, while the remaining partitions W2-W4 are designated as transmission zones for the femto access points FAP1, FAP2, FAP3.

In the embodiment depicted in FIG. 7 the femto access points FAP1, FAP2, FAP3 reduce their respective transmit powers to a level below a threshold power level, or do not transmit data at all. By contrast, during the transmission partitions W2-W4 the femto access points FAP1, FAP2, FAP3 transmit data. However, unlike the scheme depicted in FIG. 6, the femto access points FAP1, FAP2, FAP3 transmit at different power levels in different partitions. In the scheme depicted in FIG. 7 the first femto access point FAP1 transmits at a relatively high power level (P3) in the first partition and at a medium power level (P0) in the second and third partitions. Similarly, the second femto access point FAP2 transmits at a relatively high power level (P3) in the second partition and at a medium power level (P0) in the first and third partitions. The third femto access point FAP3 transmits at a relatively high power level (P3) in the third partition and at a medium power level (P0) in the first and second partitions.

Thus, the partitioning scheme depicted in FIG. 7 reduces co-channel interference between the femto access points FAP1, FAP2, FAP3 and a base station 114 proximate the femto access points FAP1, FAP2, FAP3. In addition, the fractional frequency reuse scheme reduces co-channel interference between the respective femto access points FAP1, FAP2, FAP3.

One skilled in the art will recognize that numerous variations of a fractional frequency reuse scheme may be implemented by a femto access point depending upon particular attributes of the network environment. By way of example, the embodiments depicted in FIGS. 6-7 utilize four partitions to divide the communication resource between three femto access points and one base station. In alternate embodiments more or fewer partitions may be implemented.

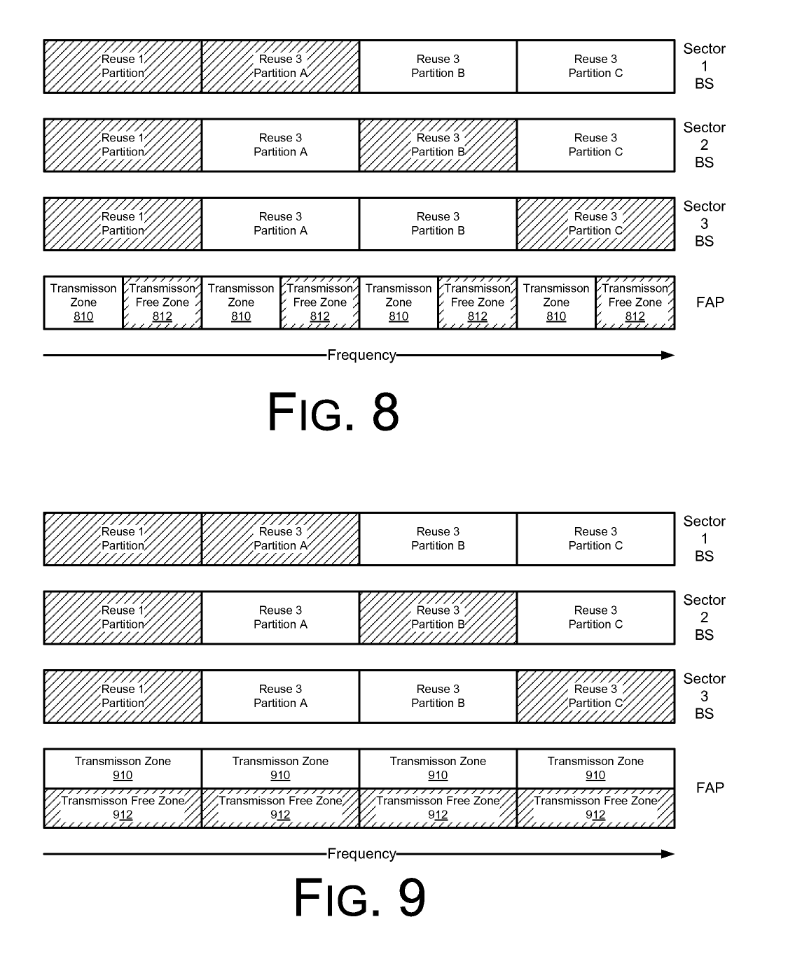

In some embodiments the base stations 114 in the network 100 may implement a fractional frequency reuse scheme to reduce interference between adjacent base stations. FIGS. 8-9 illustrate embodiments of partitions suitable to manage data transmission from a femto access point 128 in a network in which the base stations 114 implement fractional frequency reuse.

In the embodiment depicted in FIG. 8 the frequency range is divided into four partitions. In the first partition the base station 114 transmits to all sectors, i.e., a fractional frequency reuse 1 scheme. By contrast, the base station implements a fractional frequency reuse 3 scheme in partitions 2-4. Thus, the base station 114 transmits to sector 1 in the first partition, sector 2 in the second partition, and sector 3 in the third partition. One skilled in the art will recognize that the base station 114 may transmit in a different frequency range in when it is not transmitting in this frequency range. In the embodiment depicted in FIG. 8 the femto access point 128 implements a transmission zone 810 and a transmission free zone 812. Thus, there are eight partitions in total.

In the embodiment depicted in FIG. 9 the femto access point partitions in the time dimension. Referring to FIG. 8, the base stations 114 implement a fractional frequency reuse scheme like the scheme depicted in FIG. 8. However, the femto access point 128 implements a time-based partitioning scheme across the entire frequency range. Thus, in each frequency partition, the entire frequency partition will be available as a transmission zone 910 for a portion of time and the entire frequency zone will be unavailable for transmission as a transmission-free zone 912 for a portion of time. The specific portion of time and the ratio between the time dedicated to the transmission zone 910 and the transmission-free zone 912 may vary depending upon network conditions.

Thus, described herein are various network architectures, femto access points, and methods for operating such networks and femto access points to reduce co-channel interference between femto access points 128 and base stations 114, or between proximate femto access points 128. In some embodiments the femto access point 114 implements a partitioning scheme in which a communication resource, e.g., a time or frequency domain of a communication channel, is partitioned into one or more transmission-free zones in which the femto access point does not transmit data. Transmissions to and from wireless devices which are subject to interference from the femto access point may be schedule to transmit during the transmission-free zones. In alternate embodiment, which would be obvious to those skilled in the art, the base station 116 implements similar partitioning scheme and creates a transmission-free zone at the base-station.

While particular terminology is used herein to describe various components and methods, one skilled in the art will recognize that such terminology is intended to be descriptive and not limiting. By way of example, the term base station is intended to refer to a device which provides access to a network, and the term femto access point is intended to refer to a device which provides access to a lower-level network within the network serviced by the base station. Similarly, the phrase “wireless device” is intended to refer to any type of device which can transmit or receive data on the network. It will be understood that these phrases are intended to apply to multiple different wireless networking standards and to networking standards and configurations not yet described or implemented.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to manage data transmission from a femto access point, comprising:
dividing a wireless communication resource into a plurality of partitions;
reserving at least one partition of the plurality of partitions as a femto transmission-free zone in which the femto access point transmits below a threshold power level; and
reserving at least one partition of the plurality of partitions as a femto transmission zone in which the femto access point transmits above the threshold power level.

2. The method of claim 1, wherein:
dividing a wireless communication resource into a plurality of partitions comprises dividing at least one of:
a frequency range into a plurality of frequency partitions; or
a time slot into a plurality of time partitions; and
reserving at least one partition of the plurality of partitions as a femto transmission-free zone in which the femto access point operates below a threshold power level comprises reserving at least one of a frequency partition or a time partition as a femto transmission-free zone.

3. The method of claim 2, wherein the femto access point does not transmit data in the femto transmission-free zone.

4. The method of claim 1, wherein the femto access point transmits data at a specified power level in the femto transmission zone.

5. The method of claim 2, wherein the femto access point coordinates a transmission power level with one or more proximate femto access points to implement a fractional frequency reuse scheme between the femto access points.

6. The method of claim 5, wherein the femto access point:
receives a target interference based metric from the first base station;
receives an active interference based metric from one or more wireless devices coupled to the femto access point; and
adaptively adjusts a transmission power level such that the one or more wireless devices maintain an active interference based metric above the target interference based metric.

7. A femto access point, comprising:
a baseband processor;
an RF modulator/demodulator coupled to the baseband processor to modulate/demodulate data for communication within a predetermined frequency range;
one or more antennas to coupled to the RF modulator/demodulator to transceive information with one or more wireless devices via a wireless communication link; and
a control module to implement a femto transmission-free zone in at least one of a time domain or a frequency domain and in which the femto access point does not transmit data.

8. The femto access point of claim 7, wherein the control module implements a femto transmission zone in at least one of a time domain or a frequency domain and in which the femto access point transmits data.

9. The femto access point of claim 7, wherein:
the femto transmission zone is implemented in a frequency domain; and
the femto access point coordinates at lease one of a transmission power level or a frequency partition with one or more proximate femto access points to implement a fractional frequency reuse scheme between the femto access points.

10. The femto access point of claim 7 wherein the femto access point:
receives a target interference based metric from the first base station;
receives an active interference based metric from one or more wireless devices coupled to the femto access point; and
adaptively adjusts a transmission power level such that the one or more wireless devices maintain an active interference based metric above the target interference based metric.

11. A method to manage data transmission from a femto access point operating within a first cell of a wireless wide area network serviced by a first base station, comprising:
establishing a transmission power of the femto access point to transmit at a power level above a first threshold value;
dividing a wireless communication resource into a plurality of partitions; and
reserving at least one partition of the plurality of partitions as a femto transmission-free zone in which the femto access point does not transmit data.

12. The method of claim 11, further comprising reserving at least one partition of the plurality of partitions as a femto transmission zone in which the femto access point transmits data.

13. The method of claim 11, wherein the femto access point:
receives a target interference based metric from the first base station;
receives an active interference based metric from one or more wireless devices coupled to the femto access point; and
adaptively adjusts a transmission power level such that the one or more wireless devices maintain an interference based metric above the target interference based metric.

14. The method of claim 11, wherein dividing a wireless communication resource into a plurality of partitions comprises dividing at least one of:
a frequency range into a plurality of frequency partitions; or
a time slot into a plurality of time partitions.

15. The method of claim 13, wherein the femto access point coordinates a transmission power level with one or more proximate femto access points to implement a fractional frequency reuse scheme between the femto access points.

16. A base station, comprising:
a baseband processor;
an RF modulator/demodulator coupled to the baseband processor to modulate/demodulate data for communication within a predetermined frequency range;
one or more antennas to coupled to the RF modulator/demodulator to transceive information with one or more wireless devices via a wireless communication link; and
a control module to:
establish a target interference based metric for one or more wireless devices;
receive an interference based metric from the one or more wireless devices while the one or more wireless devices are in operation;
receive partition information relating to a communication resource for a femto access point operating in a service area serviced by the base station; and
schedule one or more wireless devices to operate in a femto transmission-free zone for the femto access point.

17. The base station of claim 16, wherein:
the base station implements a fractional frequency reuse scheme which divides a communication resource into a plurality of partitions; and
the femto transmission free zone comprises a portion of a frequency range in at least one of the partitions.

18. The base station of claim 16, wherein:
the base station implements a fractional frequency reuse scheme which divides a communication resource into a plurality of partitions; and
the femto transmission free zone comprises a portion of time in at least one of the partitions.

19. A method to manage communication between a base station and one or more wireless devices, comprising:
establishing a target interference based metric for the one or more wireless devices;
receiving an interference based metric from the one or more wireless devices while the one or more wireless devices are in operation;
receiving partition information relating to a communication resource for a femto access point operating in a service area serviced by the base station; and
scheduling one or more wireless devices to operate in a femto transmission-free zone for the femto access point.

20. The method of claim 19, further comprising:
implementing a fractional frequency reuse scheme which divides a communication resource into a plurality of partitions, wherein the femto transmission free zone comprises a portion of a frequency range in at least one of the partitions.

21. The base station of claim 16, further comprising:
implements a fractional frequency reuse scheme which divides a communication resource into a plurality of partitions, wherein the femto transmission free zone comprises a portion of time in at least one of the partitions.

22. A femto access point, comprising:
a baseband processor;
an RF modulator/demodulator coupled to the baseband processor to modulate/demodulate data for communication within a predetermined frequency range;
one or more antennas to coupled to the RF modulator/demodulator to transceive information with one or more wireless devices via a wireless communication link; and
a control module to:
establish a transmission power of the femto access point to transmit at a power level above a first threshold value; and
implement a femto transmission-free zone in at least one of a time domain or a frequency domain and in which the femto access point does not transmit data.

23. The femto access point of claim 22, wherein the control module implements a femto transmission zone in at least one of a time domain or a frequency domain and in which the femto access point transmits data.

24. The femto access point of claim 22, wherein the femto access point is positioned within a first cell of a wireless wide area network serviced by a first base station, and:
receives a target interference based metric from the first base station;
receives an active interference based metric from one or more wireless devices coupled to the femto access point; and
adaptively adjusts a transmission power level such that the one or more wireless devices maintain an active interference based metric above the target interference based metric.

25. The femto access point of claim 22, wherein the femto access point coordinates a transmission power level with one or more proximate femto access points to implement a fractional frequency reuse scheme between the femto access points.
